(19) United States
(12) Patent Application Publication
(10) Pub. No.: US 2025/0236978 A1
(43) Pub. Date: Jul. 24, 2025

(54) HYDROGEN GENERATION SYSTEM

(71) Applicant: HYAXIOM, INC., East Hartford, CT (US)

(72) Inventors: Joshua PRESTON, South Windsor, CT (US); Timothy William PATTERSON, JR., West Hartford, CT (US); Sean FOLEY, Windsor Locks, CT (US); Censy THOMAS, South Windsor, CT (US)

(21) Appl. No.: 18/697,820

(22) PCT Filed: Oct. 3, 2022
(86) PCT No.: PCT/US2022/045523

§ 371 Date: Apr. 2, 2024

Related U.S. Application Data
(60) Provisional application No. 63/251,650, filed on Oct. 3, 2021.

(51) Int. Cl. C25B 15/08; C25B 9/77

(52) U.S. Cl. CPC C25B 15/08; C25B 9/77

(57) ABSTRACT

A hydrogen generation system includes a plurality of cell stack assemblies, each including a plurality of cells. The cell stack assemblies are electrically connected in series. The cell stack assemblies each receive water and electricity and generate hydrogen as a result of an electrochemical reaction within the cells. The hydrogen is intended for use outside of the system and may be stored or transported to another location. A plurality of conduits carry water into and water, oxygen and hydrogen away from the cell stack assemblies. The conduits each include a dielectric section near the respective cell stack assembly to reduce or eliminate shunt currents between the cell stack assemblies. The dielectric sections may also serve to electrically isolate the cell stack assemblies from grounded portions of the system, such as a supporting frame.

### BACKGROUND

A variety of hydrogen generation processes are known. One technique includes supplying water and electricity to electrochemical cells. The hydrogen produced by such systems may be stored and used for a variety of purposes. While such systems have proven useful, they are not without challenges. For example, the electrically conductive properties of the water introduce the possibility of shunt currents between stacks. Additionally, the water may carry corrosive currents that can damage system components. Another issue present in some such systems is the undesirably high cost of some of the system components, such as rectifiers used to supply power to the system.

### SUMMARY

An illustrative example embodiment of a hydrogen generation system includes a plurality of cell stack assemblies electrically connected in series. Each cell stack assembly includes a plurality of cells. A plurality of fluid pathways each include a plurality of conduits configured to be associated with the cell stack assemblies. The plurality of conduits each include a section comprising a dielectric material. A hydrogen container that is separate from the cell stack assemblies is connected with at least one of the fluid pathways for receiving hydrogen generated by the cell stack assemblies.

In an example embodiment having at least one of the features of the hydrogen generation system of the previous paragraph, the plurality of fluid pathways comprises a first fluid pathway, a second fluid pathway, and a third fluid pathway; the first fluid pathway is configured to deliver water to the cell stack assemblies; the conduits of the first fluid pathway are first fluid conduits; each of the first fluid conduits is associated with one of the cell stack assemblies; the second fluid pathway is configured to carry at least oxygen and water away from the cell stack assemblies; the conduits of the second fluid pathway are second fluid conduits; each of the second fluid conduits is associated with one of the cell stack assemblies; the third fluid pathway is configured to carry generated hydrogen away from the cell stack assemblies; the conduits of the third fluid pathway are third fluid conduits; and each of the third fluid conduits is associated with one of the cell stack assemblies.

In an example embodiment having at least one of the features of the hydrogen generation system of any of the previous paragraphs, the section comprising dielectric material of each first fluid conduit comprises a first dielectric material, the section comprising dielectric material of each second fluid conduit comprises a second dielectric material, and the first dielectric material is different from the second dielectric material.

In an example embodiment having at least one of the features of the hydrogen generation system of any of the previous paragraphs, each first fluid conduit is connected to a first side of the associated one of the cell stack assemblies, the first fluid conduits are configured to withstand pressure up to a first threshold pressure, each second fluid conduit is connected to a second side of the associated one of the cell stack assemblies, the second fluid conduits are configured to withstand pressure up to a second threshold pressure, and the second threshold pressure is higher than the first threshold pressure.

In an example embodiment having at least one of the features of the hydrogen generation system of any of the previous paragraphs, an anode side of the cells is associated with the first side of the associated one of the cell stack assemblies and a cathode side of the cells is associated with the second side of the associated one of the cell stack assemblies.

In an example embodiment having at least one of the features of the hydrogen generation system of any of the previous paragraphs, the dielectric material of the section of at least some of the conduits comprises at least one of polytetrafluoroethylene, polyether ether ketone, or polyvinylidene fluoride.

An example embodiment having at least one of the features of the hydrogen generation system of any of the previous paragraphs includes a frame configured to support at least a portion of the cell stack assemblies and the sections comprising the dielectric material are configured to electrically isolate the cell stack assemblies from the supporting frame.

Various features and advantages of at least one disclosed example embodiment will become apparent to those skilled in the art from the following detailed description. The drawing that accompanies the detailed description can be briefly described as follows.

### BRIEF DESCRIPTION OF THE DRAWING

FIG. 1 schematically illustrates an example embodiment of a hydrogen generation system.

### DETAILED DESCRIPTION

Hydrogen generation systems designed according to an embodiment of this invention are useful for generating hydrogen that can be used for a variety of purposes separate from the system, itself. An illustrative example embodiment of a hydrogen generation system includes a plurality of cell stack assemblies, each including a plurality of cells. The cell stack assemblies are electrically connected in series. The cell stack assemblies each receive water and electricity and generate hydrogen as a result of an electrochemical reaction within the cells. The hydrogen is intended for use outside of the system and may be stored or transported to another location. A plurality of conduits carry water into and water, oxygen and hydrogen away from the cell stack assemblies. The conduits each include a dielectric section near the respective cell stack assembly to reduce or eliminate shunt currents between the cell stack assemblies. The dielectric sections may also serve to electrically isolate the cell stack assemblies from grounded portions of the system, such as a supporting frame.

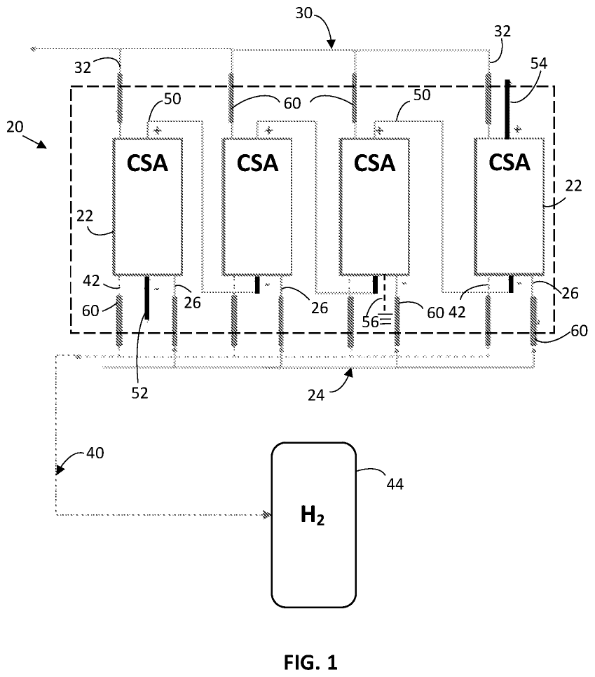

An example hydrogen generation system 20 schematically shown in FIG. 1 includes a plurality of cell stack assemblies (CSAs) 22 that each include a plurality of cells. In one example embodiment, the cells each include an anode and a cathode on opposite sides of an electrolyte. The anodes of the cells are associated with one side of the respective CSA 22 and the cathodes are associated with another, opposite side of the respective CSA 22. In some embodiments, the electrolyte is contained in a solid polymer electrolyte membrane.

The cells generate hydrogen as a result of an electrochemical reaction when water and electricity are supplied to the CSAs 22. The system 20 includes a plurality of fluid pathways including a first fluid pathway 24 that is configured to carry water to the CSAs 22. The first fluid pathway 24 includes a plurality of first fluid conduits 26 that are each associated with one of the CSAs 22.

The system 20 includes a second fluid pathway 30 configured to carry at least water away from the cell stack assemblies 22. In this example embodiment, the second fluid pathway 30 also carries oxygen away from the CSAs 22. The second fluid pathway includes a plurality of second fluid conduits 32 that are each associated with one of the CSAs 22.

The system 20 includes a third fluid pathway 40 configured to carry at least hydrogen generated by the CSAs 22 away from the CSAs 22. In this example embodiment, the third fluid pathway 40 also carries water away from the CSAs 22. The third fluid pathway 40 includes a plurality of third fluid conduits 42 that are each associated with one of the CSAs 22.

The generated hydrogen flowing through the third fluid pathway 40, which is typically mixed with water, is at least temporarily stored in a hydrogen container 44. In some embodiments, the hydrogen container 44 is used for storing the hydrogen or shipping it to another location so that the hydrogen can be used for purposes other than operating the cell stack assemblies 22. In other words, the hydrogen generated by the system 20 is removed from the system 20 and intended for a use separate or distinct from the system 20.

The cell stack assemblies 22 are electrically connected in series by an electrically conductive assembly or circuit 50 having inputs 52 (−) and 54 (+) configured to be coupled with a rectifier associated as a power source. Some embodiments include a center grounding terminal for a selected number of the CSAs 22, such as that shown in broken lines at 56, to reduce the voltage to ground potential.

The series connection provides improved cost and performance characteristics compared to an arrangement of cell stack assemblies that are electrically connected in parallel. For example, the rectifiers (not illustrated) associated with the power supply to the cell stack assemblies 22 can be much less expensive with a series connection compared to the rectifiers required with parallel connection arrangements.

The conduits 26, 32 and 42 each include a section 60 comprising a dielectric material. The sections 60 are situated near the respective cell stack assembly 22. The dielectric sections 60 electrically isolate the CSAs 22 from each other. The dielectric sections 60 have a length that is sufficient to avoid shunt currents otherwise associated with the conductivity of the water carried by the conduits 26, 32 and 42. The dielectric sections 60 also minimize or eliminate any corrosive effect of any corrosion current associated with the water.

The sections 60 comprise tubing made of a dielectric material. In some embodiments, other sections of the fluid pathways are made of a metal material, such as copper. In some embodiments, at least one of the fluid pathways is made entirely of a dielectric material.

The system 20 includes a frame 66 that is configured to support or house the components of the system 20 including the CSAs 22. The frame 66 is grounded in this embodiment and the dielectric sections 60 electrically isolate the CSAs 22 from the frame 66 and any other grounded components of the system 20 that the fluid pathways may be in contact with.

The cathode sides of the cell stack assemblies 22 are typically maintained at a higher pressure than the anode sides. The dielectric sections 60 on the different sides of the CSAs 22 can be made of different materials to accommodate or withstand the different pressures. For example, the dielectric sections 60 of the first conduits 26 and the third conduits 42 on the anode sides of the CSAs 22 comprise a first dielectric material that is configured to withstand pressures up to a first threshold pressure. The dielectric sections 60 of the second conduits 42 on the cathode sides of the CSAs 22 comprise a second dielectric material that is configured to withstand pressures up to a second threshold pressure that is higher than the first threshold pressure. In other words, a stronger or more durable material is used on the cathode side. Using different materials to accommodate the different pressures allows for selecting less expensive materials when possible, which contributes to cost savings presented by at least some embodiments.

In some embodiments, the dielectric sections 60 of the conduits comprise polytetrafluoroethylene (PTFE). Different grades of PTFE may be used on the anode sides and the cathode sides, respectively. Alternatively, the dielectric sections 60 on the cathode sides may comprise another material that is capable of withstanding higher pressures than PTFE. In some embodiments, at least some of the dielectric sections comprise polyether ether ketone (PEEK) or polyvinylidene fluoride (PVDF).

The preceding description is illustrative rather than limiting in nature. Variations and modifications to the disclosed examples may become apparent to those skilled in the art that do not necessarily depart from the essence of this invention.

We claim:

1. A hydrogen generation system, comprising:
a plurality of cell stack assemblies electrically connected in series, each cell stack assembly including a plurality of cells;
a plurality of fluid pathways, each fluid pathway including a plurality of conduits configured to be associated with the cell stack assemblies, the plurality of conduits each including a section comprising a dielectric material; and
a hydrogen container that is separate from the cell stack assemblies and connected with at least one of the fluid pathways for receiving hydrogen generated by the cell stack assemblies.

2. The hydrogen generation system of claim 1, wherein
the plurality of fluid pathways comprises a first fluid pathway, a second fluid pathway, and a third fluid pathway;
the first fluid pathway is configured to deliver water to the cell stack assemblies;
the conduits of the first fluid pathway are first fluid conduits;
each of the first fluid conduits is associated with one of the cell stack assemblies;
the second fluid pathway is configured to carry at least oxygen and water away from the cell stack assemblies,
the conduits of the second fluid pathway are second fluid conduits;
each of the second fluid conduits is associated with one of the cell stack assemblies;
the third fluid pathway is configured to carry generated hydrogen away from the cell stack assemblies;
the conduits of the third fluid pathway are third fluid conduits; and
each of the third fluid conduits is associated with one of the cell stack assemblies.

3. The hydrogen generation system of claim 2, wherein
the section comprising dielectric material of each first fluid conduit comprises a first dielectric material;
the section comprising dielectric material of each second fluid conduit comprises a second dielectric material; and
the first dielectric material is different from the second dielectric material.

4. The hydrogen generation system of claim 3, wherein
each first fluid conduit is connected to a first side of the associated one of the cell stack assemblies;
the first fluid conduits are configured to withstand pressure up to a first threshold pressure;
each second fluid conduit is connected to a second side of the associated one of the cell stack assemblies;
the second fluid conduits are configured to withstand pressure up to a second threshold pressure; and
the second threshold pressure is higher than the first threshold pressure.

5. The hydrogen generation system of claim 4, wherein
an anode side of the cells is associated with the first side of the associated one of the cell stack assemblies; and
a cathode side of the cells is associated with the second side of the associated one of the cell stack assemblies.

6. The hydrogen generation system of claim 1, wherein the dielectric material of the section of at least some of the conduits comprises polytetrafluoroethylene.

7. The hydrogen generation system of claim 1, wherein the dielectric material of the section of at least some of the conduits comprises polyether ether ketone, or polyvinylidene fluoride.

8. The hydrogen generation system of claim 1, comprising a frame configured to support at least a portion of the cell stack assemblies and wherein the sections comprising the dielectric material are configured to electrically isolate the cell stack assemblies from the supporting frame.

9. The hydrogen generation system of claim 1, wherein the section comprising the dielectric material extends along an entire length of at least some of the conduits.
